(19) United States
(12) Patent Application Publication
(10) Pub. No.: US 2014/0101862 A1
(43) Pub. Date: Apr. 17, 2014

(54) MATTRESS AND CONTROL METHOD THEREOF

(71) Applicant: TOKAI RUBBER INDUSTRIES, LTD., Aichi (JP)

(72) Inventor: Akitsugu MISAKI, Aichi (JP)

(73) Assignee: TOKAI RUBBER INDUSTRIES, LTD., Aichi (JP)

(21) Appl. No.: 14/107,401

(22) Filed: Dec. 16, 2013

Related U.S. Application Data
(63) Continuation of application No. PCT/JP2012/004818, filed on Jul. 27, 2012.

(30) Foreign Application Priority Data
Jul. 28, 2011 (JP) 2011-165314

(51) Int. Cl. A61G 7/057

(52) U.S. Cl. CPC A61G 7/05738
USPC 5/710

(57) ABSTRACT

The object of the present invention is to provide a mattress of a novel structure that can quickly perform dispersion of a body pressure acting part of a user, and can reduce discomfort felt by the user when doing a cell internal pressure switching operation, as well as a control method thereof. The present invention is provided with: a grouping step for, on the basis of a body pressure applied to each of a plurality of cells, dividing the plurality of cells into groups; a target internal pressure setting step for setting a target internal pressure of the cells for each group divided at the grouping step; and an internal pressure adjusting step for interconnecting the cells in each group and adjusting the internal pressure of the cells to the internal pressure set in the target internal pressure setting step.

### INCORPORATED BY REFERENCE

The disclosure of Japanese Patent Application No. 2011-165314 filed on Jul. 28, 2011 including the specification, drawings and abstract is incorporated herein by reference in its entirety. This is a Continuation of International Application No. PCT/JP2012/004818 filed on Jul. 27, 2012.

### BACKGROUND OF THE INVENTION

1. Field of the Invention

The present invention relates to a mattress used for a nursing care bed or the like, and to the control method thereof.

2. Description of the Related Art

From the past, mattresses having cushion action have been used for the human body support part of nursing care beds and the like, and an attempt was made to improve comfort by elastically supporting the human body.

However, for users for whom turning over in bed is difficult and the like, when a typical mattress is used continuously over a long period, the reaction force of the body pressure (pressure due to weight of the human body) acts continuously on the user's local part, so there is the risk of bedsores occurring due to worsening circulation or the like. In light of that, to prevent the occurrence of bedsores, proposed is a mattress with which it is possible to use fluid body pressure to change the acting position of the user body pressure, and to substantially disperse the reaction pressure of the body pressure acting on the user. For example, in Unexamined Japanese Patent Publication No. JP-A-2000-189472, disclosed is a constitution by which, while a load sensor sheet is arranged on the interior of the mattress, the body pressure acting surface (human body support part) of the base that supports the human body is constituted using a plurality of cells, and it is possible to adjust the internal pressure of the cells by inputting and exhausting a fluid body such as air or the like from outside to the fluid chamber of each cell. With this kind of conventional structure mattress, while the fluid body is exhausted from cells for which a high load pressure is measured, the fluid body is input to cells for which a low load pressure is measured, and by doing this, the internal pressure of the cells is changed regularly, and it is possible to prevent one part of the user's body from being pressed over a long period by the body pressure action.

However, with the method of adjusting the internal pressure of each cell such as with the mattress of JP-A-2000-189472, even if it was possible to disperse the body pressure acting part of the user, it was difficult to provide good sleep comfort to the user. In specific terms, with an adjustable mattress for which the human body support site is changed by expanding and compressing cells periodically, there were cases when users were rocked on the mattress more than necessary, and remembered a discomfort similar to seasickness.

Also, with a method of adjusting the internal pressure of each cell by inputting and exhausting a liquid body on each individual cell interior, it takes time to complete the target internal pressure switching operation, and there were cases when users felt unease or discomfort because the bumps and dents of each cell did not follow the shape of the human body midway in the switching operation. In addition, because it took time to do the internal pressure switching operation, there were cases when the user changed position during the internal pressure switching operation, and an item capable of quickly performing dispersion of the body pressure acting part without making the user feel unease had still not been proposed.

### SUMMARY OF THE INVENTION

The present invention was created with the circumstances described above as the background, and it is one object of the present invention to provide a mattress of a novel structure that can quickly perform dispersion of the body pressure acting part of the user, and can reduce the discomfort felt by the user when doing the cell internal pressure switching operation, as well as the control method thereof.

A first mode of the present invention relating to a method for controlling a mattress provides a method for controlling a mattress that includes a plurality of cells arranged on a body pressure acting surface of a base for supporting a human body, a pressure adjusting member for adjusting pressures of fluid chambers formed on interiors of the respective cells, and a body pressure measuring member for measuring body pressures applied to the respective cells, the method comprising: a first body pressure measuring step for measuring the body pressure applied to each of the cells using the body pressure measuring member; a grouping step of dividing into groups the plurality of cells based on the body pressure applied to each of the cells obtained at the first body pressure measuring step; a target internal pressure setting step for setting a target internal pressure of the fluid chambers for each of the groups divided at the grouping step; an internal pressure adjusting step for putting the fluid chambers of the respective cells in communication with each other for each of the groups divided at the grouping step, and adjusting an internal pressure of each of the fluid chambers to be the target internal pressure using the pressure adjusting member; and an independence step of making the fluid chambers of the respective cells constituting the group independent from each other after the internal pressure adjusting step ends.

With the method for controlling a mattress according to this mode, in a state with the plurality of cells grouped based on the body pressure applied to each cell, and also the fluid chamber of each of the grouped cells in communication with each other, it is possible to adjust the cell internal pressure to be the target internal pressure using the pressure adjusting member. By doing this, compared to when adjusting the internal pressure of each individual cell to be the target internal pressure, it is possible to reduce the operating instructions of the pressure adjusting member (e.g. switching valve or pump operating instructions) and to do this in batch form. Thus, it is possible to do the internal pressure adjustment of each cell in an extremely short time. Also, since internal pressure adjustment is performed by the pressure adjusting member in a state with the cells within a group in communication with each other, it is possible to smoothly and quickly achieve the cell internal pressure within the group, and possible to advantageously eliminate the sense of unease for the user.

Also, since the plurality of cells are grouped based on the body pressure applied to each cell, it is possible to group the cells following the current position of the user on the air mat. In fact, the cell internal pressure adjustment is performed in batch form for each group. This makes it possible to reduce to the extent possible the sense of unease given to the user since it becomes possible to do the cell internal pressure adjustment quickly according to the current body pressure distribution, which was not possible to achieve with only the method of simply exchanging the body pressure high places with the low places as was the case with the prior art. In addition, the cells are made independent of each other after being adjusted to the target internal pressure, thereby advantageously preventing fluctuation of the internal pressure of each cell set to the target internal pressure, the height position according to the internal pressure, or the like due to other cells. Thus, it is possible to maintain each cell in the desired state.

For grouping of the plurality of cells, it is possible to divide into groups by the size of the body pressure added to each cell, or to divide into groups by the site on the human body such as the buttocks, the legs or the like estimated from the distribution of body pressure applied to each cell, or the like.

The second mode of the present invention relating to the method for controlling the mattress according to the first mode, wherein the cells are grouped by a size of the body pressure applied to each of the cells at the grouping step, and the internal pressure adjusting step is performed in sequence from the group with a larger body pressure.

With this mode, the plurality of cells are grouped by the size of the body pressure applied to each cell, and also, the cell internal pressure adjustment is performed in sequence from the group with the larger body pressure. Accordingly, internal pressure adjustment is performed with priority from the cells supporting the buttocks or the like for which the body pressure is relatively large, for example, and sinking into the mattress is made to happen with priority from the buttocks or the like. Because of that, the body pressure dispersion effect appears more quickly, and it is possible to even more advantageously perform the cell internal pressure adjustment (height adjustment) such as one that follows the position of the user according to the current body pressure distribution, and it is possible to more advantageously reduce the unease of the user.

The third mode of the present invention relating to the method for controlling the mattress according to the second mode, wherein the internal pressure adjusting step performs such that adjustment of each of the groups up to the target internal pressure is divided into a plurality of stages, and also, the adjustment of the internal pressure is performed in sequence from the group with a larger measured value by the body pressure measuring member for each of the stages.

With this mode, adjustment up to the target internal pressure of each group is divided into a plurality of stages, and fine adjustment of the internal pressure for each of the stages is performed in sequence from the group with the large body pressure to the group with the small body pressure. This makes it possible to gradually approach the target internal pressure by changing the internal pressure of the cells of each group a little bit at a time. As a result, compared to when doing internal pressure adjustment on the next group after internal pressure adjustment is completed for each group, the difference in cell height between groups is reduced, and it is possible to perform cell internal pressure adjustment (height adjustment) such as one that follows the position of the user according to the current body pressure distribution with less sense of unease. In fact, since it is possible to do cell internal pressure adjustment in batch form for each group, it is possible to execute this kind of fine control quickly.

The fourth mode of the present invention relating to the method for controlling the mattress according to any one of the first through third modes, wherein the grouping step includes a sub grouping step of dividing at least one of the plurality of groups divided into groups based on the body pressure applied to each of the cells further into sub groups based on the position information of each of the cells.

With this mode, it is possible to subdivide the groups of cells that were grouped based on the body pressure applied to each cell into subgroups with cell position information further added. Therefore, the internal pressure adjusting step executed after the grouping step can be executed in sequence for each subgroup considering the cell position, for example, for cell subgroups positioned near the head, near the buttocks, and near the legs, and it is possible to more advantageously reduce the risk of giving a sense of unease to the user with the internal pressure adjustment step.

The fifth mode of the present invention relating to the method for controlling the mattress according to the fourth mode, further including a peripheral grouping step of grouping the cells positioned in a periphery of the sub groups divided at the sub grouping step as peripheral groups, wherein at the internal pressure adjusting step, the fluid chambers of the respective cells constituting each of the peripheral groups are in communication with each other.

With this mode, peripheral groups are constituted by the cells positioned at the periphery of the subgroup, and it is possible to have the fluid chambers of the cells of the peripheral group be in communication with each other at the subsequent internal pressure adjusting step and to perform internal pressure adjustment. By doing this, it is possible to execute smoothly without giving a sense of unease to the user the internal pressure adjustment of each subgroup considering not only the body pressure applied to the cell but also the position of the cell.

The sixth mode of the present invention relating to the method for controlling the mattress according to any one of the first through fifth modes, between the internal pressure adjusting step and the independence step, further comprising: a second body pressure measuring step for measuring the body pressure applied to each of the cells using the body pressure measuring member; an exhaust step for exhausting a fluid body of the fluid chamber using the pressure adjusting member for each group; and a third body pressure measuring step for measuring the body pressure applied to each of the cells using the body pressure measuring member during the exhaust step, wherein with measurement results of the second body pressure measuring step as comparison measurement results, the independence step is executed when there is no difference between the comparison measurement results and measurement results of the third body pressure measuring step, or when the measurement results of the third body pressure measuring step are larger, and meanwhile, processing from the exhaust step is executed again using the measurement results of the third body pressure measuring step as the comparison measurement results when the measurement results of the third body pressure measuring step are smaller than the measurement results of the second body pressure measuring step.

With this mode, after the internal pressure of the cells of each group is adjusted to the target internal pressure, it is possible to reduce the pressure of the cells of each group in sequence, and to try to further disperse the body pressure acting part of the user. Then, by repeatedly executing the third body pressure measuring step while executing the exhaust step, changes in the body pressure applied to the cell are measured during the exhaust step. Thus, when the body pressure applied to the cells continues to decrease, there is still margin for being able to make the body pressure applied to the cells smaller. By continuing the exhaust step, it is possible to make the body pressure applied to the cells smaller by reducing to the extent possible the internal pressure of the cells, making it possible to have higher level body pressure dispersion.

A first mode of the present invention relating to a mattress provides a mattress comprising: a plurality of cells arranged on a body pressure acting surface of a base supporting a human body; a pressure adjusting member for adjusting pressures of fluid chambers formed on interiors of the respective cells; a body pressure measuring member for measuring body pressures applied to the respective cells; a grouping member for dividing the plurality of cells into groups based on the body pressure applied to each of the cells measured using the body pressure measuring member; a target internal pressure setting member for setting a target internal pressure of the fluid chambers for each of the groups divided using the grouping member; and a communication/independence member for making the fluid chambers of the respective cells be in communication with or independent of each other for each of the groups divided using the grouping member, wherein in a state with the fluid chambers of the respective cells made to be in communication with each other using the communication/independence member for each group, an internal pressure of each of the fluid chambers is adjusted to the target internal pressure using the pressure adjusting member, and wherein the fluid chambers of the respective cells constituting the group for which the internal pressure has been adjusted by the pressure adjusting member are made to be independent from each other using the communication/independence member.

With the mattress of the constitution according to the present invention, in a state with the plurality of cells grouped based on the body pressure applied to each cell, and also each of the grouped cells in communication with each other, it is possible to adjust the cell internal pressure to be the target internal pressure using the pressure adjusting member. This makes it possible to quickly do cell internal pressure adjustment according to the current body pressure distribution, and to reduce to the extent possible the sense of unease given to the user. Also, since the cells are made independent of each other after being adjusted to the target internal pressure, it is possible to maintain each cell in the desired state set to the target internal pressure.

With the present invention relating to a method for controlling a mattress, included are a grouping step for dividing the plurality of cells into groups based on the body pressure applied to the cells, a target internal pressure setting step for setting the cell target internal pressure for each group divided at the grouping step, and an internal pressure adjusting step for having the fluid chamber of the cells be in communication with each other for each group and adjusting to the target internal pressure. Also, with the present invention relating to a mattress, provided are grouping member for dividing the plurality of cells into groups based on the body pressure applied to the cells, target internal pressure setting member for setting the cell target internal pressure for each group divided by the grouping member, and communication/independence member for having the fluid chambers of the cells for each group be in communication with or independent from each other, and the target internal pressure was made to be adjusted in a state with the cell fluid chambers in communication with each other by the communication/independence member. Therefore, with the mattress according to the present invention and the control method thereof, it is possible to adjust the internal pressure of the plurality of cells simultaneously in batch form for each group. As a result, it is possible to perform internal pressure adjustment of the plurality of cells quickly, and it is possible to perform dispersion of the body pressure acting part of the user quickly. Furthermore, since the height of the plurality of cells divided into groups according to the applied body pressure is changed in batch form, it is possible to have the dents and bumps of each cell quickly come close to the shape of the human body during the internal pressure switching operation, and also possible to reduce the discomfort of the user during the internal pressure switching operation.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is a perspective assembly view of a bed equipped with a mattress of the present invention;

FIG. 2 is a top view of the mattress of the present invention;

FIG. 3 is a cross sectional view of 3-3 in FIG. 2;

FIG. 4 is a perspective view of a cell;

FIG. 5 is a cross sectional view of the cell shown in FIG. 4;

FIG. 6 is a drawing of a system configuration of the mattress of the present invention;

FIG. 7 is a top view of a body pressure sensor;

FIG. 8 is a cross sectional view of 8-8 in FIG. 7;

FIG. 9 is a flow chart showing a first embodiment of a control method of the present invention;

FIG. 10 is a flow chart showing an internal pressure adjusting step;

FIG. 11 is a flow chart showing a group internal pressure fine adjusting step;

FIG. 12 is a flow chart showing a second embodiment of the control method of the present invention;

FIG. 13 is a flow chart showing a sub grouping step;

FIG. 14 is a drawing suitable for explaining first and second peripheral grouping steps for each sub group; and

FIG. 15 is a flow chart showing the internal pressure adjusting step.

### DETAILED DESCRIPTION OF PREFERRED EMBODIMENTS

Following, we will explain embodiments of the present invention while referring to the drawing.

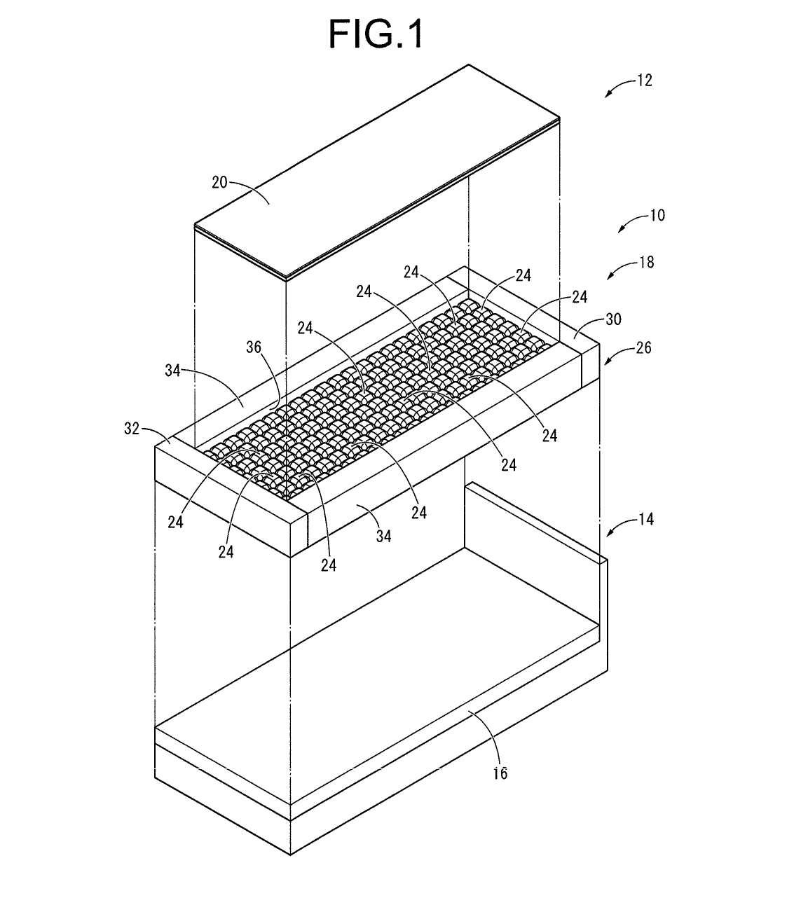

First, FIG. 1 shows a bed 12 equipped with a mattress 10 constituted according to the present invention. The bed 12 is constituted with the mattress 10 placed on the top surface of a base board 16 of a bed main body 14. The mattress 10 is constituted including a mattress main body 18 and a top mat 20.

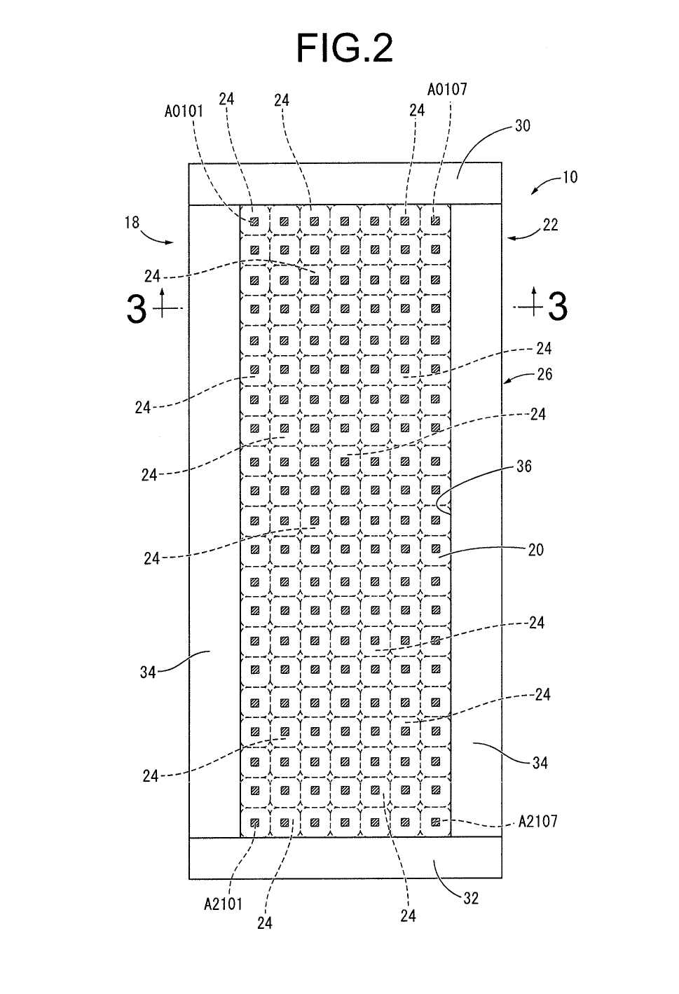

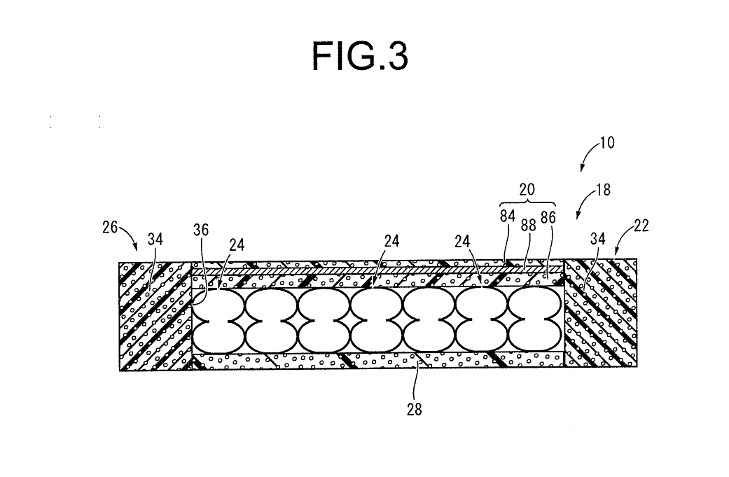

FIG. 2 and FIG. 3 show the mattress 10. In FIG. 2, the top mat 20 is shown in perspective. The mattress main body 18 is equipped with a box shaped case unit 22, and a plurality of cells 24 housed in the case unit 22. With the description hereafter, the vertical direction as a rule means the vertical direction in FIG. 3 which is the perpendicular up and down direction.

The case unit 22 is formed overall with a cushion material having elasticity, and a bottom mat 28 is fit as a base in the bottom side opening part of a framework 26, and also, the top mat 20 as a cushion layer is formed fit into the top side opening part of the framework 26.

The framework 26 is a member having elasticity formed overall using porous urethane foam, and is constituted with a head side block 30 and a foot side block 32 which are arranged to be in parallel to each other linked by a pair of side blocks 34, 34, and exhibit a rectangular frame shape in the vertical direction. The material for forming the framework 26 is not particularly restricted, and is not limited to a foam material, but considering things such as the ability to follow shape changes and the like when performing contact on the human body or back raising, it is preferable to form this using a material having elasticity such as urethane foam.

The bottom mat 28 is a rectangular plate shaped member that is thin in the vertical direction compared to the framework 26, and is formed using a porous urethane foam with this embodiment. Also, with the bottom mat 28, the shape of the vertical direction view corresponds to the opening part of the framework 26. By this kind of bottom mat 28 being fit into the bottom side opening part of the framework 26, a housing space 36 is formed on the interior of the framework 26.

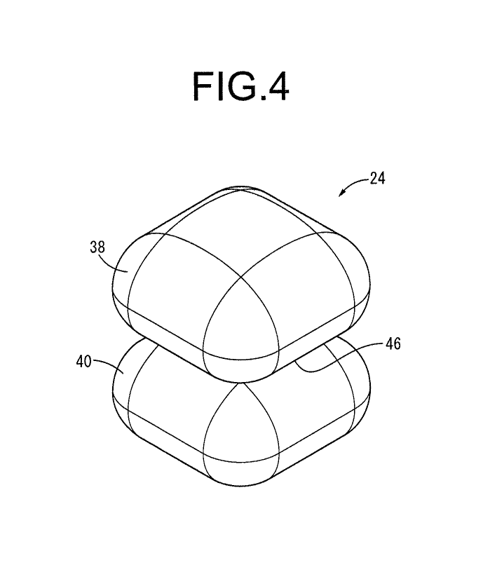

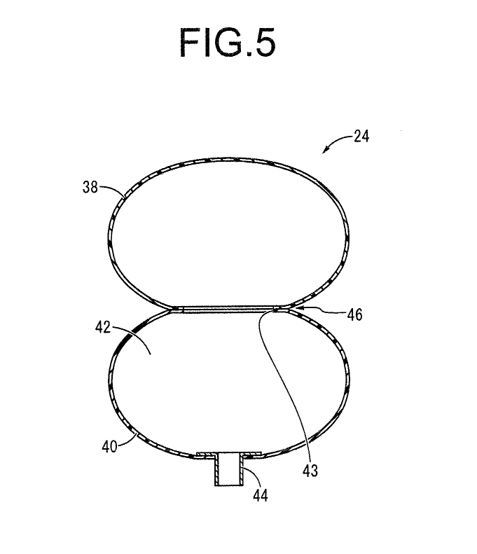

A plurality of cells 24 are arranged housed in the housing space 36. As shown in FIG. 4 and FIG. 5, the cells 24 are formed from for example urethane film or the like, and have a bag form or balloon form exhibiting a roughly rectangular shape (rounded corner rectangle shape) for which the corners are rounded in an arc form in the planar view (height direction view). In more detail, the cells 24 are formed by an upper bag portion 38 and a lower bag portion 40 which have a roughly pouch shape having an opening part, with their opening parts adhered to each other.

A fluid chamber 42 is formed on the interior of the cell 24. The fluid chamber 42 is formed by the internal space of the upper bag portion 38 and the internal space of the lower bag portion 40 in communication with each other through a communication portion 43 using their opening parts. The fluid chamber 42 is roughly sealed from the outside, and is in communication with the outside through a cylindrical port 44 provided pierced in the bottom part of the cell 24. Then, by supplying and draining a fluid body such as air or the like inside the fluid chamber 42 through the port 44, the internal pressure of the fluid chamber 42 is adjusted, and the cell 24 is made to expand and contract. The fluid body supplied and drained with the cell 24 is not limited to being air, and for example it is possible to use a liquid body such as water or the like.

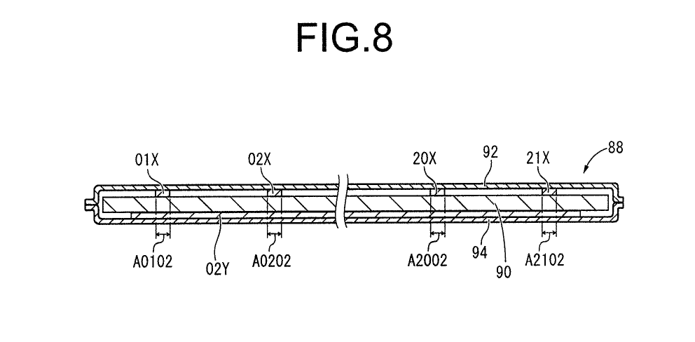

A constricted portion 46 is formed on the height direction center part of the cell 24. Specifically, by both the upper bag portion 38 and the lower bag portion 40 having a shape that gradually narrows toward the opening part, the constricted portion 46 is formed on the adhesion part (opening part) of the upper bag portion 38 and the lower bag portion 40. By doing this, the cell 24 becomes narrower in the height direction center part provided with the constricted portion 46, and there is a two stage constitution that exhibits a roughly FIG. 8 shape or a gourd shape on the vertical cross section surface during expansion.

As shown in FIG. 3, this kind of cell 24 is arranged on the top surface of the bottom mat 28, with the bottom surface adhered to the bottom mat 28 at the center part (periphery of the port 44), and is supported to be able to tilt in relation to the bottom mat 28. By doing this, the plurality of cells 24 are housed inside the housing space 36 of the case unit 22.

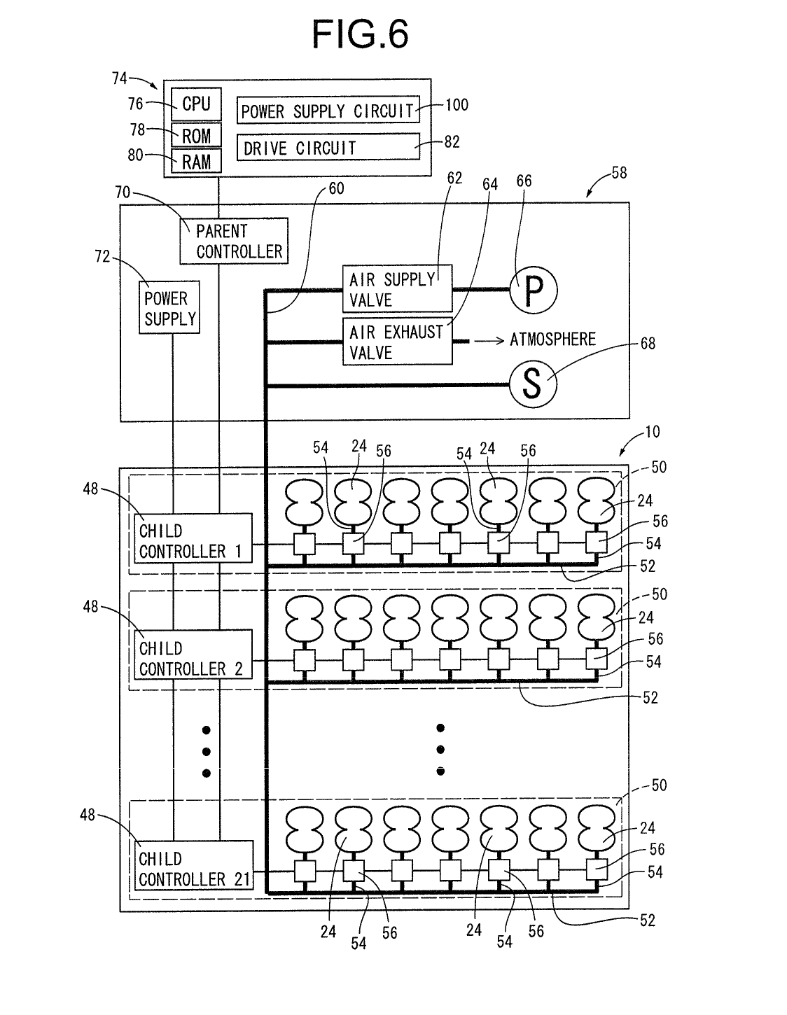

As shown schematically in FIG. 6, seven cells 24 are arranged adjacently in the horizontal direction of the mattress 10 (the horizontal direction in FIG. 2), and one cell unit 50 is constituted by these seven cells 24 and one child controller 48. By 21 sets of this kind of cell units 50 being arranged in parallel in the vertical direction of the mattress 10 (vertical direction in FIG. 2), a total of 147 (7×21 sets) cells 24 are arranged in the case unit 22.

On the cell unit 50 are provided a sub pipeline 52 and a branch pipeline 54 which branches from the sub pipeline 52 for each cell 24 and connects with the port 44 of the cell 24. Though omitted in the illustration, the port 44 of the cell 24 is provided piercing through the bottom mat 28, and the branch pipeline 54 is connected to the port 44. A cell drive valve 56 is provided on each branch pipeline 54. The cell drive valve 56 is for example an electromagnetic valve, is electrically connected to the child controller 48, and based on control signals from the child controller 48, selectively switches the branch pipeline 54 between communication and shutoff. Though details are omitted in the drawing, the child controller 48 is arranged at the side of the mattress 10. Then, the cell drive valve 56 can also be arranged under the mattress 10 inside the bed main body 14, for example, but by making the branch pipeline 54 long, it is also possible to focus the arrangement of the child controller 48 together with the seven cell drive valves 56 at the side of the mattress 10 or the like.

These cell unit 50 and sub pipelines 52 are connected to a main pipeline 60 extending from a pump device 58. Provided on the pump device 58 for example are an air supply valve 62 and an air exhaust valve 64 consisting of electromagnetic valves, for example, and these are connected to the main pipeline 60. The air supply valve 62 is connected to a pump 66 provided on the pump device 58. Meanwhile, the air exhaust valve 64 is in communication with the atmosphere. Furthermore, a pressure meter 68 is provided on the pump device 58, and is connected to the main pipeline 60.

Also, a parent controller 70 is provided on the pump device 58. The parent controller 70 is electrically connected to the air supply valve 62, the air exhaust valve 64, and the pump 66, and controls the operations of these based on control signals from a control device 74 described later. Yet further, the parent controller 70 is electrically connected to the pressure meter 68, and is able to measure the internal pressure of the main pipeline 60. Furthermore, the parent controller 70 is electrically connected to the child controller 48 of each of the cell units 50, and by sending control signals to each child controller 48, control is performed of the operation of each cell drive valve 56 for the corresponding cell unit 50. Yet further, a power supply device 72 is provided on the pump device 58. The power supply device 72 is connected to the child controller 48 of each cell unit 50, and is made to supply the drive power of the child controller 48 and the cell drive valve 56.

This kind of pump device 58 parent controller 70 is electrically connected to the control device 74. The control device 74 is equipped with a CPU (Central Processing Unit) 76, a ROM (Read Only Memory) 78, a RAM (Random Access Memory) 80, a drive circuit 82, and a power supply circuit 100 described later. Stored in the ROM 78 is a control program or the like based on a control method described later. Temporarily stored in the RAM 80 are control program calculation values or measurement values from the pressure meter 68 or the like. Then, based on the control program stored in the ROM 78, by the CPU 76 sending control signals to the parent controller 70 of the pump device 58 through the drive circuit 82, the supplying and exhausting of air to the main pipeline 60 and the operation of each cell drive valve 56 are controlled.

By doing this, based on the control signals from the control device 74, for example, the air supply valve 62 is opened and air is sent into the main pipeline 60 from the pump 66, and also, by selectively opening several among the plurality of cell drive valves 56 and putting the fluid chambers 42 of the cells 24 in communication with the main pipeline 60, it is possible to make only the pressure of the fluid chamber 42 of specified cells 24 in communication with the main pipeline 60 higher, and to increase the height of the cells 24. Also, by opening the air exhaust valve 64 and having the main pipeline 60 be in communication with the atmosphere, and selectively opening only specified cell drive valves 56 to have the fluid chambers 42 of the cells 24 be in communication with the main pipeline 60, it is possible to make only the pressure of the fluid chamber 42 of specified cells 24 connected to the main pipeline 60 lower, and to lower the height of the cells 24. In this way, with this embodiment, the pressure adjusting member for adjusting the pressure of the fluid chamber 42 of the cell 24 is constituted including the control device 74, the pump device 58, the child controllers 48 of each of the cell units 50, and the cell drive valve 56.

Then, as shown in FIG. 3, the top mat 20 is fit into the upper side opening part of the framework 26 in which the plurality of cells 24 are housed in the housing space 36, and overlaps the cells 24 inside the housing space 36. The top mat 20 has roughly the same vertical direction view shape as that of the bottom mat 28, and also, exhibits a rectangular plate shape that is thicker than the bottom mat 28. The top mat 20 has a layered structure having a front layer part 84 as a first cushion layer formed and a back layer part 86 as a second cushion layer, respectively formed using a porous urethane foam. It is possible to form the front layer part 84 and the back layer part 86 using the same material, but it is also possible to have better sleep comfort exhibited by forming these with materials of a different modulus of elasticity or the like.

With the top mat 20, between the front layer part 84 and the back layer part 86, a body pressure sensor 88 is provided as the body pressure measuring member. As the body pressure sensor 88, it is possible to use a load cell or the like using a strain gauge or magnetostrictive body, but with this embodiment, as the body pressure sensor 88, a sheet form capacitance type sensor is used. As this kind of capacitance type sensor, since it is possible to appropriately use conventionally known items, this will be kept to a summary description.

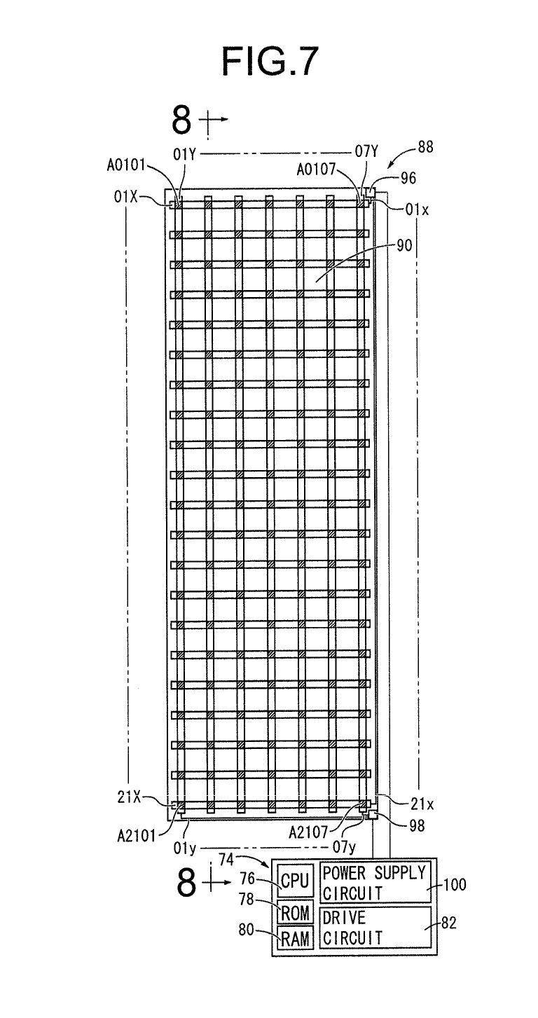

The body pressure sensor 88 is shown schematically in FIG. 7 and FIG. 8. FIG. 7 shows in perspective a dielectric layer 90 and a front side base material 92 described later, and shows cross hatching implemented on detectors A0101 to A2107 described later.

The body pressure sensor 88 is equipped with the dielectric layer 90, front side electrodes 01X to 21X as first electrode membranes, back side electrodes 01Y to 07Y as second electrode membranes, front side wirings 01x to 21x, back side wirings 01y to 07y, a front side base material 92, a back side base material 94, a front side wiring connector 96, a back side wiring connector 98, and the control device 74. In the code numbers “AOOΔΔ” of the detectors A0101 to A2107 described later, the upper two digits “OO” correspond to the front side electrodes 01X to 21X. The lower two digits “ΔΔ” correspond to the back side electrodes 01Y to 07Y.

The dielectric layer 90 is made of urethane foam as an elastomer, exhibits a rectangular plate sheet shape, and is elastically deformable. The dielectric layer 90 has a size roughly equal to the upper side opening part of the framework 26.

The front side base material 92 is made of rubber, and exhibits a rectangular plate shape. The front side base material 92 is laminated above (front side) the dielectric layer 90. The back side base material 94 is made of rubber, and exhibits a rectangular plate shape. The back side base material 94 is laminated below (back side) the dielectric layer 90.

As shown in FIG. 8, the outer edge of the front side base material 92 and the outer edge of the back side base material 94 are joined, and the front side base material 92 and the back side base material 94 are pasted together in bag form. The dielectric layer 90 is housed inside that bag. The top surface four corners of the dielectric layer 90 are spot-adhered to the bottom surface four corners of the front side base material 92. Also, the bottom surface four corners of the dielectric layer 90 are spot-adhered to the top surface four corners of the back side base material 94. In this way, the dielectric layer 90 is aligned so as not to have wrinkles occur during use in the front side base material 92 and the back side base material 94. However, the dielectric layer 90 can be elastically deformed in the horizontal direction (front-back and left-right directions) in relation to the front side base material 92 and the back side base material 94 in a state with the four corners adhered.

A total of 21 front side electrodes 01X to 21X are arranged on the top surface of the dielectric layer 90. The front side electrodes 01X to 21X are each formed including acrylic rubber and conductive carbon black. The front side electrodes 01X to 21X each exhibit a belt shape, and are formed to be able to expand and contract flexibly. The front side electrodes 01X to 21X each extend in the horizontal direction (in FIG. 7, the left-right direction). The front side electrodes 01X to 21X are arranged in the vertical direction (in FIG. 7, the up-down direction) so as to be roughly parallel to each other separated at each gap roughly equal to the array pitch of the cells 24 in the vertical direction (in FIG. 2, the up-down direction).

A total of 21 front side wirings 01x to 21x are arranged on the top surface of the dielectric layer 90. The front side wirings 01x to 21x are each formed including acrylic rubber and silver powder. The front side wirings 01x to 21x each exhibit a linear shape. The front side wiring connector 96 is arranged at the corners of the front side base material 92 and the back side base material 94. The front side wirings 01x to 21x each connect the edge part of the front side electrodes 01X to 21X and the front side wiring connector 96.

A total of 7 back side electrodes 01Y to 07Y are arranged on the bottom surface of the dielectric layer 90. The back side electrodes 01Y to 07Y are each formed including acrylic rubber and conductive carbon black. The back side electrodes 01Y to 07Y each exhibit a belt shape and are formed to be able to expand and contract flexibly. The back side electrodes 01Y to 07Y each extend in the vertical direction (in FIG. 7, the up-down direction). The back side electrodes 01Y to 07Y are arranged in the horizontal direction (in FIG. 7, the left-right direction) so as to be roughly parallel to each other separated at each gap roughly equal to the array pitch of the cells 24 in the horizontal direction (in FIG. 2, the left-right direction). In this way, the front side electrodes 01X to 21X and the back side electrodes 01Y to 07Y are arranged in a mutually orthogonal grid form seen from above or from below.

A total of 7 back side wirings 01y to 07y are arranged on the bottom surface of the dielectric layer 90. The back side wirings 01y to 07y are each formed containing acrylic rubber and silver powder. The back side wirings 01y to 07y each exhibit a linear shape. The back side wiring connector 98 is arranged at the corners of the front side base material 92 and the back side base material 94. The back side wirings 01y to 07y each connect the end part of the back side electrodes 01Y to 07Y and the back side wiring connector 98.

As shown by the cross hatching in FIG. 7, the detectors A0101 to A2107 are arranged at the part for which the front side electrodes 01X to 21X and the back side electrodes 01Y to 07Y intersect in the vertical direction (the overlapping part). The detectors A0101 to A2107 are each equipped with a portion of the front side electrodes 01X to 21X, a portion of the back side electrodes 01Y to 07Y, and a portion of the dielectric layer 90. A total of 147 (=7×21) detectors A0101 to A2107 are arranged, the same number as the cells 24 housed inside the housing space 36 of the case unit 22. The detectors A0101 to A2107 are arranged evenly across roughly the entire surface of the dielectric layer 90.

As shown in FIG. 7, the control device 74 is electrically connected to the front side wiring connector 96 and the back side wiring connector 98. The power supply circuit 100 is provided on the control device 74. The power supply circuit 100 applies a periodic rectangular wave voltage to the detectors A0101 to A2107 in sequence by scanning. In the ROM 78, a map indicating the correspondence between the electrostatic capacity of the capacitor constituted by the detectors A0101 to A2107 and the body pressure (load) is stored in advance. Meanwhile, in the RAM 80, the electrostatic capacity of the detectors A0101 to A2107 input from the front side wiring connector 96 and the back side wiring connector 98 is temporarily stored. Then, the CPU 76 is made to detect the body pressure acting on the detectors A0101 to A2107 based on the map stored in the ROM 78 from the electrostatic capacity of the detectors A0101 to A2107 stored in the RAM 80.

As shown in FIG. 3, the top mat 20 equipped with this kind of body pressure sensor 88 is fit into the upper side opening part of the framework 26, and is made to overlap the plurality of cells 24 housed inside the housing space 36 of the framework 26. By doing this, the body pressure sensor 88 broadens along the bottom mat 28 via the plurality of cells 24, and also, as shown in FIG. 2, each of the detectors A0101 to A2107 of the body pressure sensor 88 overlaps the corresponding cell 24. As a result, the body pressure applied to each cell 24 can be detected by the body pressure sensor 88.

As shown in FIG. 1, the mattress 10 constituted in this way overlaps the base board 16 of the bed main body 14. Then, when the user lies down on the mattress 10, the body pressure of the user acts on the top mat 20, the plurality of cells 24, and the bottom mat 28, and is supported by the base board 16 of the bed main body 14. Then, by the body weight (body pressure) acting facing downward based on the gravity acting on the user, each top surface of the top mat 20, the cells 24, the bottom mat 28, and the base board 16 is used as the body pressure acting surface.

Next, we will describe a first embodiment of the mattress 10 relating to the control method of adjusting the internal pressure of the cells 24. First, in the ROM 78 of the control device 74, the group information table shown in Table 1 is stored. Stored in the group information table are the size of the body pressure applied to the cells 24 and the target internal pressure corresponding to each of the plurality of groups (with this embodiment, six groups, from Group 1 to Group 6). From Group 1 in sequence, items for which the body pressure applied to the cell 24 is smaller are allocated to the group information table. Also, the target internal pressure is not set for Group 1 for which the body pressure applied to the cell 24 is the smallest, and internal pressure adjustment is not performed. In Table 1, “a” is a constant.

TABLE 1

| Group | Body Pressure (mmHg) | Target Internal Pressure (Pa) |
|---|---|---|
| Group 1 | 0 p to 10 p | Stay at current level |
| Group 2 | 10 p to 15 p | 3a |
| Group 3 | 15 p to 18 p | 2a |
| Group 4 | 18 p to 20 p | 1.5a |
| Group 5 | 20 p to 24 p | 1.2a |
| Group 6 | 24 p or greater | 1.0a |

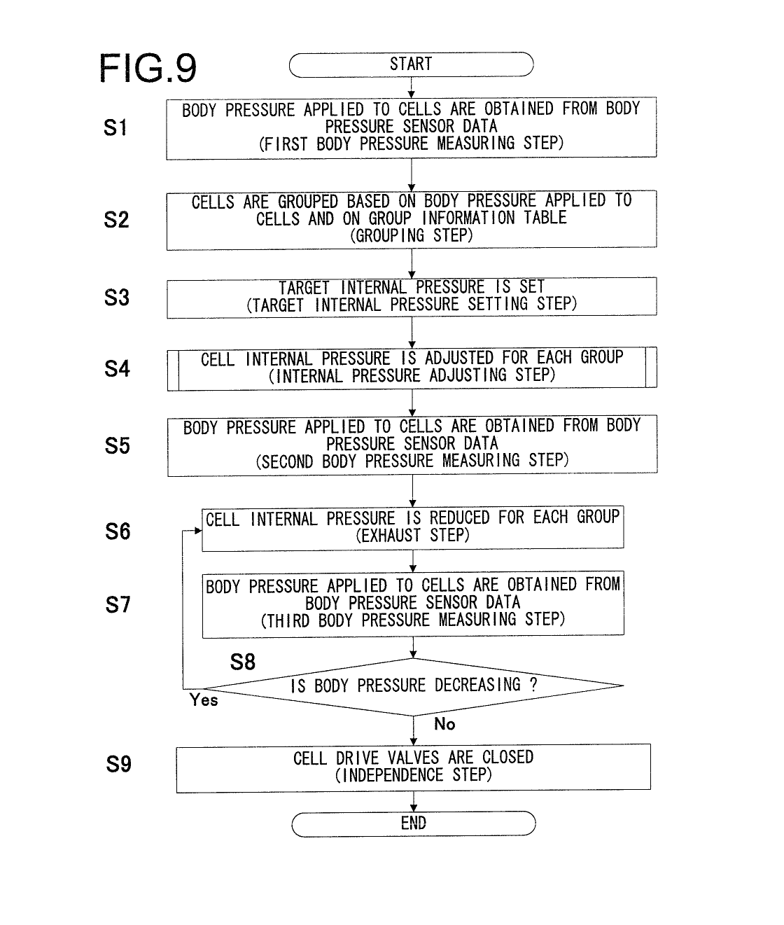

FIG. 9 shows the processing contents of the CPU 76 of the control device 74. First, at step S1, the CPU 76 implements the first body pressure measuring step for measuring the body pressure applied to the cells 24 for all of the cells 24 from the body pressure sensor 88.

Next, at S2, the CPU 76 implements the grouping step for allocating each of the cells 24 to any of the corresponding groups of Group 1 to Group 6 based on the body pressure obtained at S1 for all the cells 24 and on the group information table shown in Table 1, and storing this in the RAM 80. For example, when the body pressure obtained at S1 for a specified cell 24 is 17 p (mmHg), based on the group information table, the concerned cell 24 is allocated to Group 3 and that is stored in the RAM 80. In this way, with this embodiment, the grouping member is constituted by the group information table stored in ROM 78, including S2.

Next, at S3, the CPU 76 implements the target internal pressure setting step of fetching the target internal pressure of the cells 24 based on the group to which the cells 24 are allocated and on the group information table shown in Table 1 for all the cells 24, and storing this in the RAM 80. For example, the cells 24 allocated to Group 3 have 2 a (Pa) set as the target internal pressure based on the group information table. As is clear from this, the target internal pressure is determined for each group, and the same target internal pressure is set for the cells 24 in the same group. In this way, with this embodiment, the target internal pressure setting member is constituted by the group information table stored in the ROM 78, including S3.

Subsequently, at S4, the CPU 76 implements the internal pressure adjusting step for adjusting the internal pressure for each group for each of the cells 24. When adjusting the internal pressure of the cells 24 for each group, while the cell drive valves 56 of the cells 24 allocated to the group subject to adjustment are opened, the cell drive valves 56 of the cells 24 allocated to the other groups are closed. By doing this, the fluid chambers 42 of the plurality of cells 24 allocated to the group subject to adjustment are in communication with each other through the sub pipeline 52 and the main pipeline 60. As a result, the internal pressure of the cells 24 in communication with each other is balanced and this becomes a specified balanced internal pressure. Then, the balanced internal pressure is measured by the pressure meter 68, and when the target internal pressure is higher than the balanced internal pressure, by the air supply valve 62 being opened and the fluid chamber 42 being put in communication with the pump 66, the pressure is increased inside the fluid chamber 42. Meanwhile, when the target internal pressure is lower than the balanced internal pressure, by the air exhaust valve 64 being opened and the fluid chamber 42 being put in communication with the atmosphere, the pressure is decreased inside the fluid chamber 42.

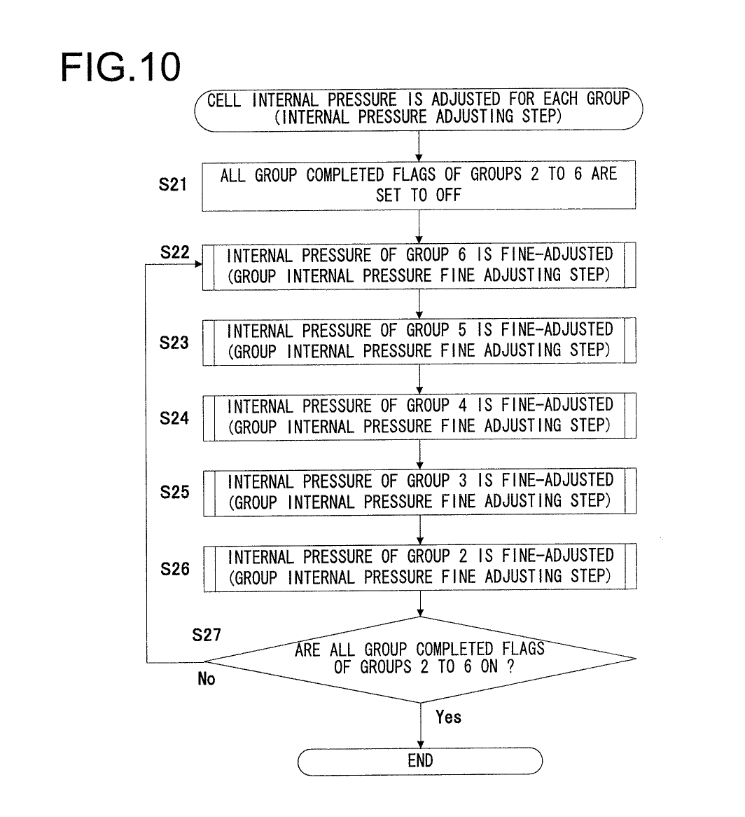

Here, with the internal pressure adjusting step of S4, in sequence for each group, it is also possible to adjust the internal pressure of the next group after adjustment of the internal pressure of a certain group is completed, but as shown in FIG. 10, it is preferable to divide the internal pressure adjustment for each group into a plurality of stages of group internal pressure fine adjusting steps (S22 to S26), and to repeatedly perform the group internal pressure fine adjusting step (S22 to S26) of each group in sequence from Group 6 to Group 2.

To implement the internal pressure adjusting step shown in FIG. 10, as group completed flags corresponding respectively to Group 2 through Group 6, a group 2 completed flag through a group 6 completed flag are respectively stored in the RAM 80. These group completed flags are flags indicating whether or not the internal pressure adjustment of the cells 24 of the corresponding group is completed, and when the group completed flag is on, that means that adjustment of the internal pressure of the cells 24 of the corresponding group is completed (set to the target internal pressure), and when the group completed flag is off, that indicates that the adjustment of the internal pressure of the cells 24 of the corresponding group is not completed (not set to the target internal pressure). At S21, as the initialization process, the CPU 76 sets all the group completed flags from Group 2 through Group 6 to off.

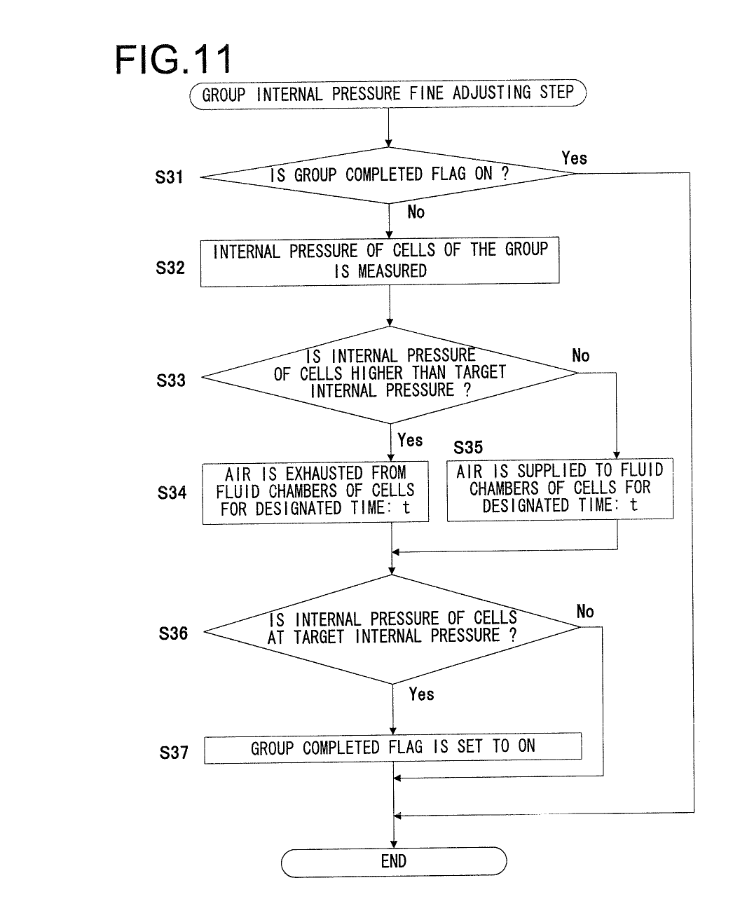

Next, at S22, the CPU 76 implements the group internal pressure fine adjusting step that does fine adjusting of the internal pressure to come close to the target internal pressure for the cells 24 allocated to Group 6 for which the body pressure applied to the cell 24 is the greatest. FIG. 11 shows the group internal pressure fine adjusting step. First, at S31, when the group 6 completed flag stored in the RAM 80 is on (S31=Yes), the CPU 76 regards the internal pressure adjustment of Group 6 as being already completed, and ends the group internal pressure fine adjusting step (S22) of Group 6. Meanwhile, when the group 6 completed flag stored in the RAM 80 is off (S31=No), at S32, the CPU 76 opens the cell drive valves 56 of the cells 24 allocated to Group 6, and in a state with the fluid chambers 42 of the cells 24 of Group 6 in communication with each other, the internal pressure of the cells 24 allocated to Group 6 is measured by the pressure meter 68.

Next, at S33, the CPU 76 compares the internal pressure of the cells 24 of Group 6 measured at S32 and the target internal pressure set at the target internal pressure setting step (S3), and when the internal pressure of the cells 24 is higher than the target internal pressure (S33=Yes), at S34, the CPU 76 drives the air exhaust valve 64 in a state with the fluid chambers 42 of the cells 24 of Group 6 in communication with each other, and exhausts air from the fluid chambers 42 of the cells 24 for a designated time: t that is preset at for example 1 second, 2 seconds or the like, and reduces the pressure of the fluid chambers 42. Meanwhile, when the internal pressure of the cells 24 is lower than the target internal pressure (S33=No), at S35, the CPU 76 drives the air supply valve 62 and the pump 66 in a state with the fluid chambers 42 of the cells 24 of Group 6 in communication with each other, and supplies air to the fluid chambers 42 of the cells 24 for a designated time: t, and increases the pressure of the fluid chambers 42.

Then, at S36, the CPU 76 measures the internal pressure of the cells 24 allocated to Group 6, and when the internal pressure of the cells 24 was the target internal pressure (S36=Yes), at S37, the Group 6 group completed flag is set to on, and the group internal pressure fine adjusting step (S22) for group 6 ends. Meanwhile, when the internal pressure of the cells 24 is not the target internal pressure (S36=No), the group internal pressure fine adjusting step (S22) for group 6 ends without making changes in the group completed flag. For the judgment of whether or not the internal pressure of the cells 24 is the target internal pressure at S36, a suitable acceptable range is set from the target internal pressure, and it is also possible to judge that the internal pressure of the cells 24 is at the target internal pressure when the internal pressure of the cells 24 is within the acceptable range from the target internal pressure. Also, by observing the internal pressure of the cells 24 with the pressure meter 68 during increasing and decreasing of pressure by S34 and S35, when the internal pressure of the cells 24 has reached the target internal pressure, it is also possible to end increasing or decreasing of pressure before the designated time: t has elapsed at S34 and S35 or the like.

Subsequently, at S23 through S26, in sequence of to Group 2 from Group 5 for which the body pressure applied to the cells 24 is the greatest, the same as with Group 6 at S22 noted previously, the group internal pressure fine adjusting step (see FIG. 11) is implemented with which fine adjustment is done of the internal pressure of the cells 24 allocated to the group, making it come close to the target internal pressure. Then, at S27, when all the group completed flags of all the groups from Group 2 through Group 6 are on (S27=Yes), the cells 24 of all the groups are considered to be set to the target internal pressure, and the internal pressure adjusting step (S4) ends. Meanwhile, when there is even one item left for which the group completed flag is not on (S27=No), the processing of S22 and thereafter is repeated, and the internal pressure fine adjusting is repeated for the cells 24 of the group not set to the target internal pressure. In other words, in sequence of to Group 2 from Group 6 for which the body pressure applied to the cells 24 is the greatest, by repeatedly executing the group internal pressure fine adjusting step (S22 to S26), fine pressure increase or pressure decrease for a designated time is repeated, the internal pressure of the cells 24 gradually approaches the target internal pressure, and at the stage for which the cells 24 of all the groups of Group 2 through Group 6 are set to the target internal pressure, the internal pressure adjusting step (S4) is completed.

By the above, the internal pressure of each of the cells 24 is adjusted to the target internal pressure and the height of the cell 24 is set according to the body pressure applied to the cell 24. As a result, the top mat 20 is a shape that follows the user's body surface, and by supporting the user's body with a broader surface area, it is possible to disperse the body pressure.

To obtain better body pressure dispersion results, it is preferable to lower the internal pressure of the cells 24, and to further broaden the contact surface area of the user's body surface and the mattress. In light of that, with this embodiment, at S5 and thereafter, the internal pressure of the cells 24 is reduced. In specific terms, the CPU 76 implements the second body pressure measuring step for measuring the body pressure applied to the cell 24 from the body pressure sensor 88 at S5 for each of Group 2 through Group 6 for which the target internal pressure is set.

Next, at S6, the CPU 76 implements the exhaust step for reducing the pressure of the internal pressure of the cells 24 for each group for the cells 24 of Group 2 through Group 6. During the exhaust step, with the cells 24 of Group 2 through Group 6, the cell drive valves 56 are opened for each group, and in a state with the fluid chambers 42 of the same group in communication with each other, the internal pressure is reduced by the air inside the fluid chambers 42 for which the air exhaust valve 64 is open being exhausted into the atmosphere.

While air is being exhausted from the fluid chambers 42 with the exhaust step (S6), at S7, the CPU 76 implements the third body pressure measuring step for measuring the body pressure applied to the cells 24 from the body pressure sensor 88 for the cells 24 of the group for which the exhaust step is being implemented. Then, at S8, the CPU 76 uses the body pressure of the measurement results of the second body pressure measuring step (S5) as the comparison measurement results, and when the body pressure of the measurement results of the third body pressure measuring step (S7) is smaller than the comparison measurement results (S8=Yes), it is conceivable that the applied body pressure is reduced by reducing the pressure of the cells 24, and there will be an improvement in the body pressure dispersion effect. Thus, it is conceivable that there is still margin for improvement of the body pressure dispersion effect by making the internal pressure of the cells 24 smaller. In light of that, while continuing pressure reduction of the cells 24 by returning to S6 and continuing the exhaust step, at S7, the third body pressure measuring step is executed. Then, at S8, with the body pressure of the measurement results of the previous third body pressure measuring step (S7) as the comparison measurement results, when the body pressure of the measurement results of this time's third body pressure measuring step (S7) is smaller than the comparison measurement results (S8=Yes), the exhaust step (S6) and the third body pressure measuring step (S7) are executed repeatedly. Meanwhile, with the body pressure of the measurement results of the second body pressure measuring step (S5) or the third body pressure measuring step (S7) as the comparison measurement results, when the comparison measurement results and the body pressure of the measurement results of this time's third body pressure measuring step (S7) are the same (S8=No), even if the pressure is reduced for the cells 24, it is not possible to make further improvement in the body pressure dispersion effect, and the process from S9 and thereafter is executed. Also, with the body pressure of the measurement results of the second body pressure measuring step (S5) or the previous third body pressure measuring step (S7) as the comparison results, when the body pressure of the measurement results of this time's third body pressure measuring step (S7) is larger than the comparison measurement results (S8=No), the body pressure applied to the cells 24 increases along with the reduction of pressure of the cells 24, so the cells 24 are considered to be in a so-called “bottomed out state” collapsed as far as they can go, and the process of S9 and thereafter is executed. In other words, at S6 through S8, the CPU 76 monitors changes in the body pressure applied to the cells 24 during the exhaust step (S6), and while the body pressure applied to the cells 24 is decreasing (S8=Yes), the exhaust step (S6) continues, but on the other hand, at the point that the body pressure applied to the cells 24 is no longer decreasing (S8=No), the exhaust step (S6) ends, and the process of S9 and thereafter is implemented.

Then, at S9, the CPU 76 closes the cell drive valves 56 of all the cells 24, and implements the independence step for making the fluid chambers 42 of all the cells 24 independent from each other. By doing this, the internal pressure of each of the cells 24 is fixed, and the control process is completed. In this way, with this embodiment, the communication/independence member for putting into communication or making independent from each other the fluid chambers 42 of the respective cells 24 for each group is constituted to include the cell drive valve 56, the sub pipeline 52, and the main pipeline 60.

With the mattress 10 constituted according to this embodiment and its control method, the plurality of cells 24 were divided into groups by the size of the applied body pressure, and made so as to simultaneously adjust the internal pressure in batch form for each group. By doing this, compared to when individually controlling the internal pressure for each cell 24, it is possible to perform internal pressure adjustment of the cells 24 more quickly. As a result, it is possible to reduce to the extent possible the sense of unease given to the user during internal pressure adjustment of the cells 24. Also, by putting the fluid chambers 42 of the cells 24 for each group in communication with each other, free movement of air is allowed between the cells 24 within the same group during internal pressure adjustment, and an effect can be expected of the mattress 10 naturally following the body shape of the user. Together with that, by having the fluid chambers 42 of the cells 24 of the same group in communication with each other, it is possible to adjust the internal pressure of all the cells 24 with a single air supply valve 62, pump 66, and air exhaust valve 64, so it is possible to simplify the pipeline, and to simplify the control.

Also, the internal pressure adjustment of the cells 24 is performed in sequence from Group 6 for which the body pressure applied to the cells 24 is the largest. By doing this, internal pressure adjustment is performed first from the cells 24 supporting the head, buttocks or the like for which the body pressure applied to the cells 24 is large, and sinking into the mattress 10 is first from the head, the buttocks or the like. By doing this, the contact area of the periphery of the head or buttocks and the mattress 10 is rapidly increased, and it is possible to quickly have a body pressure dispersion effect appear. Furthermore, by implementing the internal pressure adjustment of each group in sequence for each group in stages rather than completing it all at once, it is possible to avoid having a big difference in the height of the cells 24 between groups, and to change the overall shape of the mattress 10 a little bit at a time. As a result, it is possible to change the mattress shape without giving a big sense of unease to the user.

Yet further, by providing the exhaust step (S6), it is possible to lower the internal pressure of the cells 24 after changing the surface shape of the mattress 10 according to the body pressure distribution of the user. By doing this, it is possible to obtain a better body pressure dispersion effect. Then, by exhausting the air inside the fluid chambers 42 while measuring the changes in the body pressure applied to the cells 24 with the second body pressure measuring step (S5) and the third body pressure measuring step (S7), it is possible to perform pressure reduction effectively within an effective range that improves the body pressure dispersion effect without reducing pressure more than necessary.

Following, we will describe a second embodiment of the control method for adjusting the internal pressure of the cells 24 for the mattress 10. First, the group information table shown in Table 2 is stored in the ROM 78 of the control device 74. Stored in the group information table are the size of the body pressure applied to the cells 24 and the target internal pressure corresponding to each of the plurality of groups (with this embodiment, three groups, Group A through Group C). With the group information table of this embodiment, in sequence from Group A, items are allocated from the item for which the body pressure applied to the cells 24 is the greatest, the target internal pressure is not set for group C for which the body pressure applied to the cells 24 is the smallest, and internal pressure adjustment is made not to be performed. Further stored in the group information table are the target internal pressures respectively set for a first peripheral group and a second peripheral group described later, specified based on the cell 24 position information. In Table 2, “a” is a constant.

TABLE 2

| Group | Body Pressure (mmHg) | Target Internal Pressure (Pa) |
|---|---|---|
| Group A | 24 p or greater | 0.5a |
| Group B | 20 p to 24 p | 1.0a |
| Group C | 0 p to 20 p | Stay at current level |
| First Peripheral | — | 1.2a |
| Group | | |
| Second | — | 1.5a |
| Peripheral | | |
| Group | | |

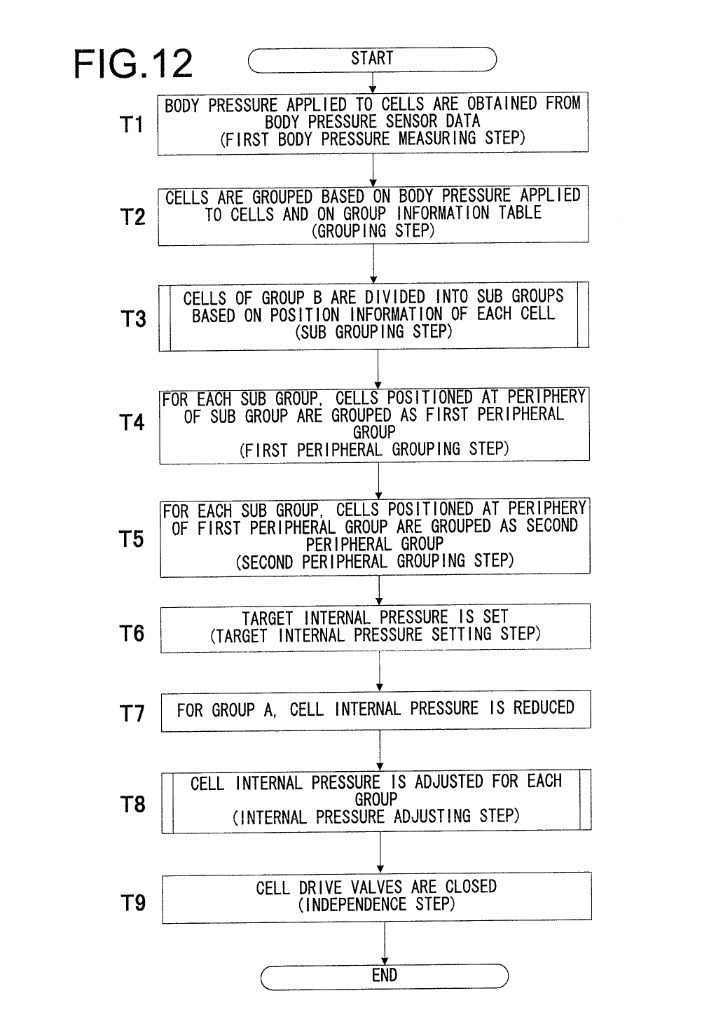

FIG. 12 shows the process contents of the CPU 76 of the control device 74. First, at T1, the CPU 76 implements the first body pressure measuring step of measuring the body pressure applied to the cells 24 for all the cells 24 from the body pressure sensor 88.

Next, at T2, the CPU 76 implements the grouping step of allocating each of the cells 24 to a corresponding group among Group A through Group C based on the body pressure obtained at T1 and the group information table shown in Table 2 for all the cells 24, and storing this in the RAM 80. For example, for a specified cell 24, when the body pressure obtained at T1 is 21 p (mmHg), the concerned cell 24 is allocated to Group B based on the group information table, and this is stored in the RAM 80. In this way, with this embodiment, the grouping member is constituted with the group information table stored in the ROM 78, including T2.

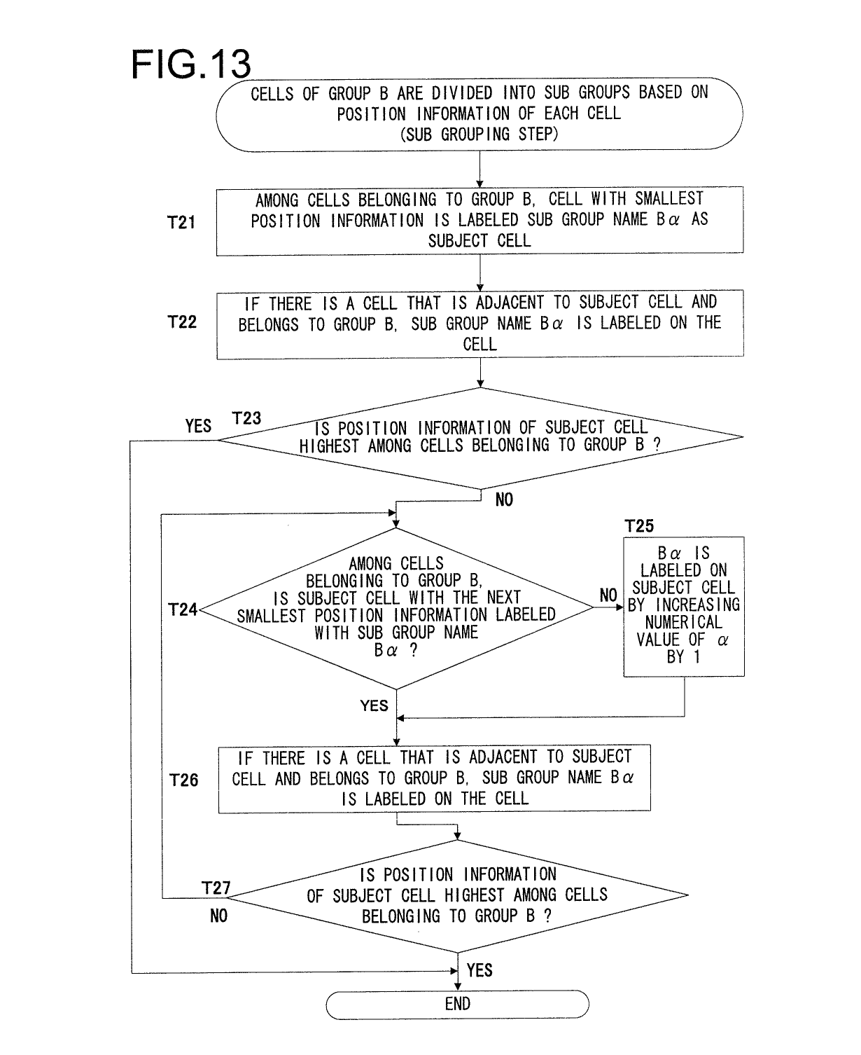

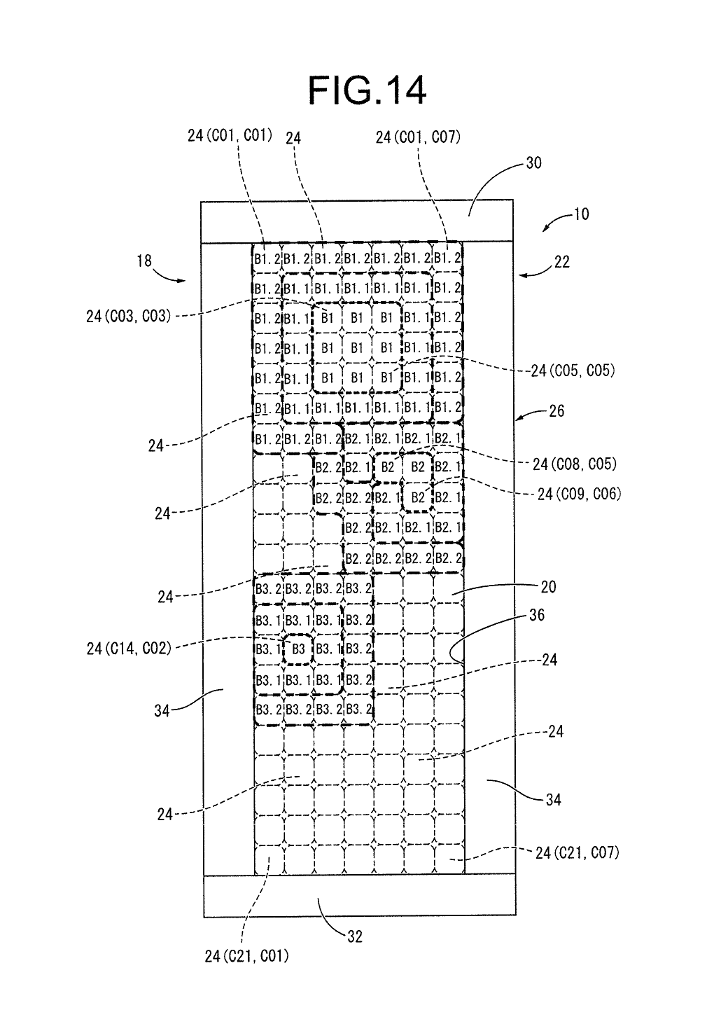

Subsequently at T3, among the Group A through Group C grouped based on the body pressure applied to each of the cells 24 at T2, the CPU 76 implements a sub grouping step of further dividing Group B into sub groups B1, B2, B3 . . . based on the position information of each cell. This sub grouping step is performed according to the process contents shown in FIG. 13. Here, the cell position information is set using the lower four digits numbers of the detectors A0101 to A2107 arranged directly above each cell 24. In specific terms, as shown in FIG. 14, the position information of the cell 24 positioned at the furthest left side of the topmost row is (C01, C01), and the position information of the cell 24 positioned at the furthest right side of the topmost row is (C01, C07). Also, the position information of the cell 24 positioned at the furthest left side of the bottommost row is (C21, C01), and the position information of the cell 24 positioned at the furthest right side of the bottommost row is (C21, C07). The position information of each of these cells 24 is stored in the ROM 78 of the control device 74.

Therefore, for the numerical values of the position information of each cell 24, the cell 24 positioned at the furthest left side of the topmost row (C01, C01) is the smallest at “0101,” and this becomes larger as it goes in the rightward direction of the topmost row, rising as far as “0107” with the cell 24 at the furthest right side of the topmost row (C01, C07). The cell 24 of the next largest numerical value of the position information of the cells 24 becomes “0201” for the cell 24 positioned furthest to the left side of the row directly below the topmost row (C02, C01). Here as well, the numerical value of the position information of the cell 24 becomes sequentially larger as it moves in the rightward direction, and at the cell 24 positioned at the furthest right side of the row directly below the topmost row (C02, C07), rises up to “0207.”

In this way, the numerical value of the position information of each cell 24 rises sequentially as it moves from the cell 24 of the left edge of the topmost row to the cell 24 of the right edge, and the next after the cell 24 of the right edge of each row is the cell 24 of the left edge of the row directly below that, and the value further rises sequentially as it moves to the cell of the right edge of that same row. Then, the numerical value of the position information of the cell 24 positioned at the furthest right side of the bottommost row (C21, C07) is the highest at “2107.”

To implement the sub grouping step shown in FIG. 13, first, at T21, among the cells belonging to Group B, the CPU 76 detects the cell with the smallest position information numerical value as the subject cell, labels a sub group name Bα on that cell and stores it in the RAM 80. Here, α is a variable, and with this embodiment, increases in ascending order from 1. With this embodiment, as shown by example in FIG. 14, the cell 24 (C03, C03) among the cells belonging to Group B has the smallest information position numerical value, and is labeled as B1.

Next, at T22, the CPU 76 detects the presence or absence of a cell 24 that is adjacent to the subject cell 24 (C03, C03) labeled B1 that also belongs to Group B, and when an applicable cell 24 is detected, labels it with the sub group name B1, and stores this in the RAM 80. With this embodiment, the detection range of the adjacent cells 24 is the subject cell 24 (Cx, Cy)'s right side cell 24 (Cx, Cy+1), the bottom side cell (Cx+1, Cy), and also the diagonally right downward side cell 24 (Cx+1, Cy+1). With the specific example shown in FIG. 14, at T22, B1 is labeled on cell 24 (C03, C04), cell 24 (C04, C03), and cell 24 (C04, C04).

Next, at T23, the CPU 76 makes a determination of whether or not the subject cell 24 (C03, C03), among the cells 24 belonging to Group B, is the cell with the highest position information numerical value. When the numerical value of the subject cell 24 position information is the highest (T23=Yes), all the cells 24 belonging to Group B are judged to have been divided into sub groups, and the sub grouping step (T3) ends. Meanwhile, when the information position numerical value of the subject cell 24 is not the highest (T23=No), the CPU 76 continues on to execute T24.

At T24, the CPU 76 determines whether or not the subject cell with the next smallest position information numerical value among the cells belonging to Group B is already labeled with the sub group name Bα. When the subject cell 24 is already labeled with the sub group name Bα (T24=Yes), the CPU 76 advances to T26, detects the presence or absence of a cell 24 that is adjacent to the subject cell 24 and belongs to Group B, and when an applicable cell 24 is detected, labels it with the sub group name Bα, and stores that in the RAM 80. With the example shown in FIG. 14, since the subject cell 24 (C03, C04) is already labeled with the sub group name B1, at T26, the sub group name B1 is labeled on the adjacent cell 24 (C03, C05), cell 24 (C04, C04), and cell 24 (C04, C05) belonging to Group B.

Meanwhile, when the subject cell 24 has still not been labeled with the sub group name Bα (T24=No), the CPU 76 labels Bα on the subject cell 24 by increasing the variable α by 1 at T25, and this is stored in the RAM 80. With the specific example shown in FIG. 14, when executing T24 for the subject cell 24 (C08, C05) that is not adjacent to the cell 24 (C05, C05) belonging to the sub group B1, the sub group B1 is not labeled on the applicable subject cell 24 (C08, C05). Therefore, the judgment at T24 is No, and at T25, the CPU 76 increases the variable α by 1 and labels the subject cell 24 (C08, C05) as B2, and stores this in the RAM 80.

Then, continuing with T26, the CPU 76 detects the presence or absence of a cell 24 that is adjacent to the subject cell 24 (C08, C05) and also belongs to Group B, and when the applicable cell 24 is detected, labels this with the sub group name B2, and stores this in the RAM 80. With the example shown in FIG. 14, the sub group name B2 is labeled on the adjacent cell 24 (C08, C06) and the cell 24 (C09, C06) that are adjacent to the subject cell 24 (C08, C05) and also belong to Group B.

Next, at T27, the CPU 76 judges whether or not the subject cell 24 (C03, C04) or the subject cell 24 (C08, C05), among the cells 24 belonging to Group B, are the cells with the highest position information numerical value. When the subject cell 24 position information numerical value is the highest (T27=Yes), all of the cells 24 belonging to Group B are judged to have been divided into sub groups, and the sub grouping step (T3) ends. Meanwhile, when the subject cell 24 position information numerical value is not the highest (T27=No), the CPU 76 repeatedly executes steps T24 through T27.

By executing the sub grouping step described above in ascending order from the item with the smallest position information numerical value of the cells 24 belonging to Group B, the cells 24 belonging to Group B are divided into sub groups B1, B2, B3 . . . for which the position information of each cell is also added. With the example shown in FIG. 14, with classification into sub groups B1, B2, and B3, the cells 24 belonging to Group B are roughly divided into a group near the user's head, a group near the buttocks, and a group near the legs.

Next, at T4 in FIG. 12, the CPU 76 executes a first peripheral grouping step for grouping the cells 24 positioned at the periphery of the sub groups B1, B2, and B3 as first peripheral groups B1.1, B2.1, and B3.1. For example, as shown in FIG. 14, first, the CPU 76 labels B1.1 on the cells 24 adjacent to each cell 24 belonging to the sub group B1, and stores that in the RAM 80. With this embodiment, the detection range of the adjacent cells 24 is the subject cell 24 (Cx, Cy)'s upper side cell 24 (Cx−1, Cy) and its left and right adjacent cells 24 (Cx−1, Cy−1) and (Cx−1, Cy+1), and the subject cell 24 (Cx, Cy)'s left and right adjacent cells 24 (Cx, Cy−1) and (Cx, Cy+1), as well as the subject cell 24 (Cx, Cy)'s lower side cell 24 (Cx+1, Cy) and its left-right adjacent cells 24 (Cx+1, Cy−1) and (Cx+1, Cy+1), and the B1.1 labeling is sequentially performed in ascending order of the position information numerical value of the cells 24 of the sub group B1. With the B1.1 labeling, for cells already labeled B1 or B1.1, the label attached first has priority and remains.

By executing the first peripheral grouping step for each sub group B1, B2, and B3 using the method noted above, as shown in FIG. 14, B1.1, B2.1, and B3.1 are labeled on the cells 24 enclosing the sub groups B1, B2, and B3 respectively, constituting the first peripheral groups B1.1, B2.1, and B3.1, and these are stored in the RAM 80.

Next, at T5, the CPU 76 executes a second peripheral grouping step for grouping the cells positioned in the periphery of the first peripheral groups B1.1, B2.1, and B3.1 as second peripheral groups B1.2, B2.2, and B3.2 for each sub group B1, B2, and B3. The detection range of the adjacent cell 24 and labeling method are the same as with the first peripheral grouping step, and B1.2 is labeled on the cells 24 adjacent to the cells 24 labeled B1.1, B2.2 is labeled on the cells 24 adjacent to the cells 24 labeled B2.1, and furthermore, B3.2 is labeled on the cells 24 adjacent to the cells labeled B3.1. By doing this, as shown in FIG. 14, B1.2, B2.2, and B3.2 are labeled on the cells 24 enclosing the first peripheral groups B1.1, B2.1, and B3.1 respectively, constituting the second peripheral groups B1.2, B2.2, and B3.2, and these are stored in the RAM 80.

Next, at T6, the CPU 76 implements the target internal pressure setting step that fetches the target internal pressure of each cell 24 based on the group to which the cell 24 is allocated and on the group information table shown in Table 2 for all the cells 24, and stores this in the RAM 80. For example, 0.5 a (Pa) is set as the target internal pressure based on the group information table for the cells 24 allocated to Group A. Also, 1.2 a (Pa) is set as the target internal pressure based on the group information table for the cells 24 allocated to the first peripheral groups B1.1, B2.1, and B3.1. As is clear from this, the target internal pressure is determined for each group, and the same target internal pressure is set for the cells 24 of the same group. In this way, with this embodiment, the target internal pressure setting member is constituted by the group information table stored in the ROM 78, including T6.

Next, at T7, the CPU 76 executes pressure reduction of the cell internal pressure up to the target internal pressure 0.5 a (Pa) for each of the cells 24 belonging to Group A. The internal pressure adjusting step of Group A is preferably performed individually for each cell 24, and in a state with the drive valves 56 of all the cells 24 other than the single cell 24 for which pressure reduction is performed closed, the drive valve 56 of the single cell 24 is opened, and by opening the air exhaust valve 64 and having the fluid chamber 42 in communication with the atmosphere, the pressure is reduced inside the fluid chamber 42. By doing this, by having each of the fluid chambers 42 of the cells 24 belonging to Group A for which the measured body pressure value is the greatest in communication with each other, it is possible to reduce the risk of any of the cells 24 bottoming out.

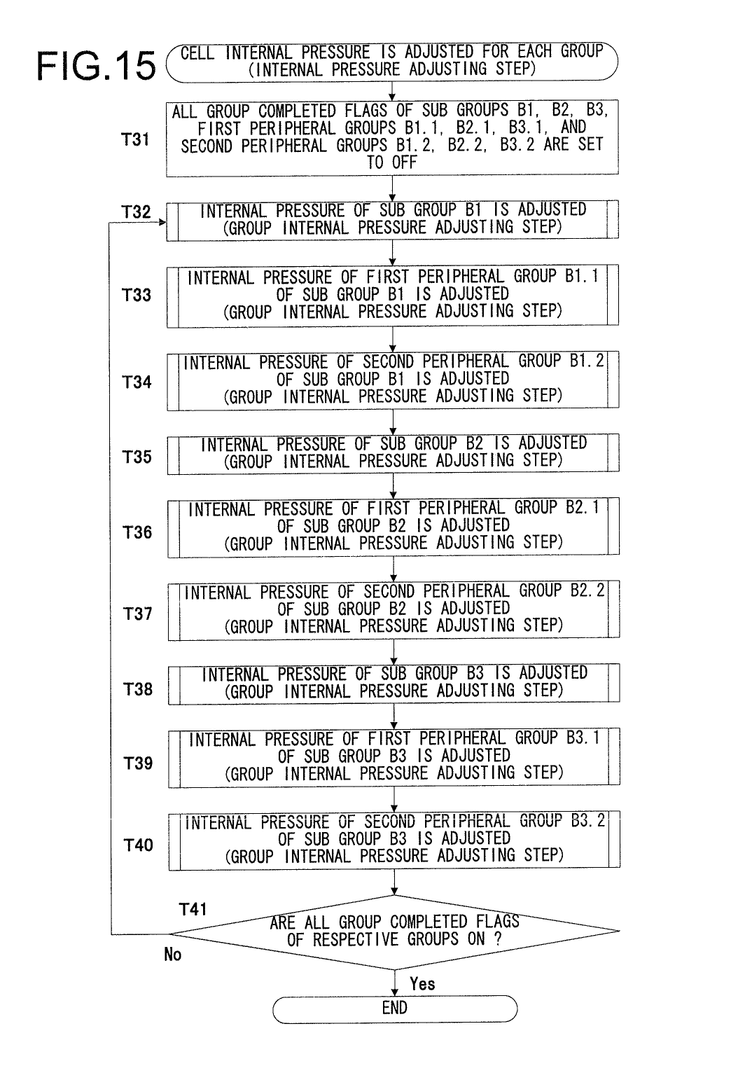

Next, at T8, for each of the cells 24 belonging to Group B, the CPU 76 executes the internal pressure adjusting step shown in FIG. 15 in sequence respectively for the sub groups B1, B2, and B3 and their first peripheral groups B1.1, B2.1, and B3.1, and second peripheral groups B1.2, B2.2, and B3.2 which underwent sub grouping based on the position information of each cell 24.

To implement the internal pressure adjusting step shown in FIG. 15, respectively corresponding to the sub groups B1 to B3, the first peripheral groups B1.1 to B3.1, and the second peripheral groups B1.2 to 3.2, the group completed flags B1 to B3, B1.1 to B3.1, and B1.2 to 3.2 are stored in the RAM 80. These group completed flags are flags indicating whether or not the internal pressure adjustment of the cells 24 of the corresponding group is completed, and when the group completed flag is on, this indicates that the internal pressure adjustment of the cells 24 of the corresponding group is completed (set to the target internal pressure), and when the group completed flag is off, this indicates that the internal pressure adjustment of the cells 24 of the corresponding group is not completed (not set to the target internal pressure). Then, at T31, the CPU 76 sets all the group completion flags of the sub groups B1 to B3, the first peripheral groups B1.1 to B3.1, and the second peripheral groups B1.2 to 3.2 to off as the initialization process.

Next, at T32, the CPU 76 implements the internal pressure adjusting step that adjusts the internal pressure and sets it to the target internal pressure for the cells 24 allocated to the sub group B1. In specific terms, the CPU 76 opens the cell drive valves 56 of the cells 24 allocated to the sub group B1, and in a state with the fluid chambers 42 of the cells 24 of the sub group B1 in communication with each other, the internal pressure of the cells 24 belonging to the sub group B1 is measured by the pressure meter 68.

Next, the CPU 76 compares the measured internal pressure of the cells 24 of the sub group B1 with the target internal pressure set with the target internal pressure setting step (T6) noted above, and when the internal pressure of the cells 24 is greater than the target internal pressure, in a state with the fluid chambers 42 of the cells 24 of the sub group B1 in communication with each other, the air exhaust valve 64 is driven, air is exhausted from the fluid chambers 42 of the cells 24 for example for a designated time: t of 1 second, 2 seconds or the like, that is set in advance, and the pressure is reduced for the fluid chambers 42. Meanwhile, when the internal pressure of the cells 24 is lower than the target internal pressure, in a state with the fluid chambers 42 of the cells 24 of the sub group B1 in communication with each other, the air supply valve 62 and the pump 66 are driven, air is supplied to the fluid chambers 42 of the cells 24 for a designated time: t, and the pressure is increased for the fluid chambers 42.

Then, the internal pressure of the cells 24 allocated to the sub group B1 is measured using the pressure meter 68, and when the internal pressure of the cells 24 is the target internal pressure, the CPU 76 turns the group completed flag on, and the group internal pressure adjusting step (T32) for sub group B1 ends. Meanwhile, when the internal pressure of the cell 24 is not the target internal pressure, the group internal pressure adjusting step (T32) ends for the sub group B1 without changing the group completed flag.

Next, at T33, the CPU 76 implements the internal pressure adjusting step for adjusting the internal pressure and setting it to the target internal pressure for the cells 24 allocated to the first peripheral group B1.1. The internal pressure adjusting step at T33, the same as with T32, is executed with the cell drive valves 56 of the cells 24 allocated to the sub group B1.1 opened, in a state with the fluid chambers 42 of the cells 24 of the sub group B1.1 in communication with each other, and the execution contents of the CPU 76 are the same as those for T32. Next, at T34, the internal pressure adjusting step for adjusting the internal pressure and setting it to the target internal pressure is implemented for the cells 24 allocated to the second peripheral group B1.2. The execution contents of the CPU 76 for the internal pressure adjusting step at T34 are the same as that of T32.

Next, at T35 to T37, the CPU 76 sequentially executes the same internal pressure adjusting step for the cells 24 allocated to the sub group B2 and its first peripheral group B2.1, and second peripheral group B2.2. Furthermore, at T38 to T40, the CPU 76 sequentially executes the same internal pressure adjusting step for the cells 24 allocated to sub group B3 and its first peripheral group B3.1 and second peripheral group B3.2.

Then, at T41, when the group completed flag is on for all the groups of sub groups B1 to B3, first peripheral groups B1.1 to B3.1, and second peripheral group B1.2 to 3.2 (T41=Yes), this means that all the group cells 24 are set to the target internal pressure, and the internal pressure adjusting step (T8) ends. Meanwhile, when there is even one group completed flag remaining that is not on (T41=No), the process of T32 and thereafter is repeated, and internal pressure adjustment is repeated for the cells 24 of the group not set to the target internal pressure.

In other words, with this embodiment, Group B divided into groups only by the size of the body pressure applied to the cells 24 is further divided into sub groups B1, B2, and B3 with the position information of the cells 24 also added, and the internal pressure adjusting step T8 is executed for each sub group B1, B2, and B3 including the first peripheral groups B1.1, B2.1, and B3.1 and second peripheral groups B1.2, B2.2, and B3.2 constituted by the cells 24 positioned in the periphery of those sub groups B1, B2, and B3. Then, with the internal pressure adjusting step for each group, the same steps as the internal pressure fine adjusting step (S22 to S26) with the control method of the first embodiment are repeatedly executed, and fine pressure increase or pressure decrease of a designated time is repeated so that the internal pressure of the cells 24 gradually approaches the target internal pressure, and at the stage that all the group cells 24 of the sub groups B1, B2, and B3, the first peripheral groups B1.1, B2.1, and B3.1, and the second peripheral groups B1.2, B2.2, and B3.2 are set to the target internal pressure, the internal pressure adjusting step (T8) is completed.

Then, at T9, the CPU 76 implements the independence step that closes the cell drive valves 56 of all the cells 24, and makes the fluid chambers 42 of all the cells independent from each other. By doing this, the internal pressure of each cell 24 is fixed, and the control process is completed. Also, with this embodiment, the same as with the previously noted embodiment, the communication/independence member for making the fluid chambers 42 of each cell 24 in communication with or independent from each other is constituted including the cell drive valve 56, the sub pipeline 52, and the main pipeline 60.

With the mattress 10 constituted according to this embodiment and its control method, as described above, the internal pressure of each cell 24 is adjusted to the target internal pressure, and the height of the cell 24 is set according to the body pressure applied to the cell 24. As a result, the same as with the first embodiment of the control method of the present invention, the top mat 20 has a shape that follows the body surface of the user, and by supporting the body of the user with a broader surface area, it is possible to disperse the body pressure. Furthermore, with this embodiment, the internal pressure adjusting step T8 of each cell 24 of Group B can be performed in sequence for the sub group B1 near the head, the sub group B2 near the buttocks, and the sub group B3 near the legs which are sub-divided according to the position information of the cell 24, and it is possible to more advantageously reduce the risk of giving a sense of unease to the user with the internal pressure adjusting step. In addition, the internal pressure of the cells 24 is adjusted from the center toward the periphery as with B1 to B1.1 to B1.2, including the first peripheral groups B1.1, B2.1, and B3.1, and the second peripheral groups B1.2, B2.2, and B3.2 of the periphery of the sub groups B1, B2, and B3. Thus, it is possible to execute the internal pressure adjusting step more smoothly without giving a sense of unease to the user.

Above, we gave a detailed description of a plurality of embodiments of the present invention, but the present invention is not limited by those specific notations. For example, with the first embodiment of the control method of the present invention, as the group division of the plurality of cells 24, rather than focusing individually on each cell 24, and classifying into each group from the size of the body pressure applied to each cell as with the embodiments noted above, it is also possible to measure the body pressure applied to all the cells 24 provided in the mattress 10, and to estimate items as having the buttocks or the head on the cells 24 with a relatively large body pressure, and as having an arm or a leg on the cells 24 with a relatively small body pressure, and to do internal pressure adjusting by dividing into groups of each site of the human body such as the head, the arm or the like from the body pressure distribution or the like.

Also, the internal pressure adjusting for each group does not necessarily have to be performed in sequence from the group with the large body pressure applied to the cells 24, and it is also possible to perform it in sequence from the group with the small body pressure applied to the cells 24, or to perform it in random sequence unrelated to the size of the body pressure applied to the cells 24. Furthermore, it is not absolutely necessary to have the exhaust step (S6), or the second body pressure measuring step (S5) and the third body pressure measuring step (S7) before and after the exhaust step with the previously noted embodiments.

Also, with the embodiments noted above, all 21 cell units 50 shared use of the air supply valve 62, the pump 66, and the air exhaust valve 64 provided on the pump device 58, but for example, it is also possible to provide an air supply valve, a pump, and an air exhaust valve for each of the cell units 50, and to operate them simultaneously between each cell unit 50. Furthermore, instead of the cell drive valves 56 with the previously noted embodiments, it is also possible to add or decrease the internal pressure of the cell 24 of the same group simultaneously by simultaneously operating the air supply valve, the pump, and the air exhaust valve provided on the cells 24 of the same group. In such a case, when supplying air, the fluid chambers 42 of the cells 24 of the same group are put into communication with each other through the sub pipeline 52, while on the other hand, when exhausting air, they are put in communication with each other through the atmosphere.

Furthermore, the specific shape of the cells 24 used for the mattress 10 with the embodiments noted above are nothing more than examples, and various prior art known shapes can be suitably used. Therefore, as the cell 24, this does not have to be a two-tier shape as with the previously noted embodiments, but it is also possible to be a simple bag shaped item or the like.

Furthermore, with the second embodiment of the control method of the present invention, the internal pressure adjusting step of the sub groups B1, B2, and B3 is performed with the fluid chambers 42 of the cells 24 belonging to those sub groups in communication with each other, but as with the internal pressure adjusting step with Group A, it is also possible to perform the internal pressure adjusting step independently in a state with each cell 24 independent from the other cells 24. By doing this, with respect to the cells 24 belonging to Group B for which a relatively large body pressure is applied, it is possible to reduce the risk that any cell 24 bottoms out due to their fluid chambers 42 being in communication with each other.

What is claimed is:

1. A method for controlling a mattress that includes a plurality of cells arranged on a body pressure acting surface of a base for supporting a human body, a pressure adjusting member for adjusting pressures of fluid chambers formed on interiors of the respective cells, and a body pressure measuring member for measuring body pressures applied to the respective cells, the method comprising:
a first body pressure measuring step for measuring the body pressure applied to each of the cells using the body pressure measuring member;
a grouping step of dividing into groups the plurality of cells based on the body pressure applied to each of the cells obtained at the first body pressure measuring step;
a target internal pressure setting step for setting a target internal pressure of the fluid chambers for each of the groups divided at the grouping step;
an internal pressure adjusting step for putting the fluid chambers of the respective cells in communication with each other for each of the groups divided at the grouping step, and adjusting an internal pressure of each of the fluid chambers to be the target internal pressure using the pressure adjusting member; and
an independence step of making the fluid chambers of the respective cells constituting the group independent from each other after the internal pressure adjusting step ends.

2. The method for controlling the mattress according to claim 1, wherein the cells are grouped by a size of the body pressure applied to each of the cells at the grouping step, and the internal pressure adjusting step is performed in sequence from the group with a larger body pressure.

3. The method for controlling the mattress according to claim 2, wherein the internal pressure adjusting step performs such that adjustment of each of the groups up to the target internal pressure is divided into a plurality of stages, and also, the adjustment of the internal pressure is performed in sequence from the group with a larger measured value by the body pressure measuring member for each of the stages.

4. The method for controlling the mattress according to claim 1, wherein the grouping step includes a sub grouping step of dividing at least one of the plurality of groups divided into groups based on the body pressure applied to each of the cells further into sub groups based on position information of each of the cells.

5. The method for controlling the mattress according to claim 4, further comprising a peripheral grouping step of grouping the cells positioned in a periphery of the sub groups divided at the sub grouping step as peripheral groups, wherein at the internal pressure adjusting step, the fluid chambers of the respective cells constituting each of the peripheral groups are in communication with each other.

6. The method for controlling the mattress according to claim 1, between the internal pressure adjusting step and the independence step, further comprising:
a second body pressure measuring step for measuring the body pressure applied to each of the cells using the body pressure measuring member;
an exhaust step for exhausting a fluid body of the fluid chamber using the pressure adjusting member for each group; and
a third body pressure measuring step for measuring the body pressure applied to each of the cells using the body pressure measuring member during the exhaust step,
wherein with measurement results of the second body pressure measuring step as comparison measurement results, the independence step is executed when there is no difference between the comparison measurement results and measurement results of the third body pressure measuring step, or when the measurement results of the third body pressure measuring step are larger, and meanwhile, processing from the exhaust step is executed again using the measurement results of the third body pressure measuring step as the comparison measurement results when the measurement results of the third body pressure measuring step are smaller than the measurement results of the second body pressure measuring step.

7. A mattress comprising:
a plurality of cells arranged on a body pressure acting surface of a base supporting a human body;
a pressure adjusting member for adjusting pressures of fluid chambers formed on interiors of the respective cells;
a body pressure measuring member for measuring body pressures applied to the respective cells;
a grouping member for dividing the plurality of cells into groups based on the body pressure applied to each of the cells measured using the body pressure measuring member;
a target internal pressure setting member for setting a target internal pressure of the fluid chambers for each of the groups divided using the grouping member; and
a communication/independence member for making the fluid chambers of the respective cells be in communication with or independent of each other for each of the groups divided using the grouping member,
wherein in a state with the fluid chambers of the respective cells made to be in communication with each other using the communication/independence member for each group, an internal pressure of each of the fluid chambers is adjusted to the target internal pressure using the pressure adjusting member, and
wherein the fluid chambers of the respective cells constituting the group for which the internal pressure has been adjusted by the pressure adjusting member are made to be independent from each other using the communication/independence member.
